(19) United States
(12) Patent Application Publication
(10) Pub. No.: US 2011/0037693 A1
(43) Pub. Date: Feb. 17, 2011

(54) Cursor control device

(75) Inventor: Hsiao-Long Chiang, Taipei City (TW)

Correspondence Address: BACON & THOMAS, PLLC, 625 SLATERS LANE, FOURTH FLOOR, ALEXANDRIA, VA, 22314-1176, US

(73) Assignee: EKTOUCH CO., LTD., TUCHENG CITY (TW)

(21) Appl. No.: 12/662,788

(22) Filed: May 4, 2010

(30) Foreign Application Priority Data
May 5, 2009 (TW) 098207649

(51) Int. Cl. G09G 5/08

(52) U.S. Cl. 345/157

(57) ABSTRACT

A cursor control device is disclosed to include a hollow elongated circuit module holder having a top opening, a sleeve sleeved onto the circuit module holder and movable leftwards and rightwards and rotatable forwards and backwards relative to the circuit module without friction and a circuit module accommodated in the circuit module holder and adapted for sensing the direction and amount of movement of the sleeve relative to the circuit module holder and producing a signal indicative of the direction and amount of movement of the sleeve relative to the circuit module holder for controlling a cursor on a display screen of an electronic device.

This application claims the priority of Taiwan patent application number 098207649 filed on May 5, 2009.

### BACKGROUND OF THE INVENTION

1. Field of the Invention

The present invention relates to cursor control technology and more particularly, to a cursor control device formed of a hollow elongated circular module holder, a sleeve sleeved onto the circular module holder and axially slidable and transversely rotatable by the user and a circuit module mounted in the circular module holder for sensing the direction and movement of the sleeve and outputting a control signal to control a cursor on a display screen of an external electronic device.

2. Description of the Related Art

Following fast development of modern technology and the electronic industry, many kinds of consumer electronics, such as computer, mobile telephone, digital camera, personal digital assistant and etc., have entered into our daily life. Further, following popularization of network, people may use the internet to search for information on the World Wide Web. Through the internet, people can watch online favorite movies, TV shows, cartoons, music videos and much more. Through the internet, people can also play web games and online games, send e-mails, go online shopping, make a subscription or online payment, or transfer money.

Further, a computer has multiple functions, bringing convenience to the user. Further, a computer may be equipped with a keyboard and/or mouse for controlling a cursor on a display screen. When operating a computer mouse, a user may rest the wrist of the hand on the desk or a mouse pad and then move the computer mouse or click the button of the computer mouse with the fingers. However, when going to move the computer mouse over a big area, the user must lift the wrist from the desk or mouse pad. Excessive or improper use of a computer may cause pain in the wrist (the so-called carpal tunnel syndrome). In order to eliminate this problem, wrist rests are created. A wrist rest is a device used to support the wrist while typing or when using a computer mouse. However, leaning the wrists on a wrist rest for long periods can put a lot of pressure on the undersides of the wrists. This may cause carpal tunnel syndrome to develop. Actually, a wrist rest does help align the user's hands and wrists while mousing. Further, an improperly used wrist rest may actually cause more repetitive stress injuries for those who mouse for extended periods of time.

Therefore, it is desirable to provide an orthopedically engineered cursor control device that eliminates the aforesaid problems.

### SUMMARY OF THE INVENTION

The present invention has been accomplished under the circumstances in view. It is one object of the present invention to provide a cursor control device, which is orthopedically engineered for comfortable use to control a cursor on a display screen of an electronic device. It is another object of the present invention to provide a cursor control device, which produces less friction during operation, assuring operating stability.

To achieve these and other objects of the present invention, a cursor control device comprises a hollow elongated circuit module holder having a top opening, a sleeve sleeved onto the circuit module holder and movable leftwards and rightwards and rotatable forwards and backwards relative to the circuit module without friction and a circuit module accommodated in the circuit module holder and adapted for sensing the direction and amount of movement of the sleeve relative to the circuit module holder and producing a signal indicative of the direction and amount of movement of the sleeve relative to the circuit module holder for controlling a cursor on a display screen of an electronic device to grab a web page and to scroll up or down the web page or to click a menu selection. Further, the circuit module comprises a control switch, which produces a triggering signal when the user presses the sleeve.

Further, the circuit module holder is made from a self-lubricating material, facilitating movement of the sleeve. Therefore, the sleeve can be moved smoothly relative to the circular module holder without causing much friction resistance.

Further, the circuit module holder is formed of a first holder shell and a second holder shell. Further, the circuit module is accommodated in the second holder shell and affixed to the second holder shell. Because the circuit module is protected inside the circular module holder and does not requires any extra installation space in the electronic device, the cursor control device has an integrated outer appearance and a small-size characteristic.

### BRIEF DESCRIPTION OF THE DRAWINGS

FIG. 1 is a perspective view of a cursor control device in accordance with the present invention.

FIG. 2 is an exploded view of a part of the cursor control device in accordance with the present invention.

FIG. 3 is an exploded view of the cursor control device in accordance with the present invention.

FIG. 4 is a schematic drawing showing a status of use of the cursor control device in accordance with the present invention.

FIG. 5 is a sectional side view of the cursor control device in accordance with the present invention, showing movement of the sleeve in X-axis direction relative to the circuit module holder.

FIG. 6 is a sectional side view of the cursor control device in accordance with the present invention, showing axial movement of the sleeve in Y-axis direction relative to the circuit module holder.

FIG. 7 is a sectional side view of the cursor control device in accordance with the present invention, showing the sleeve pressed downwards relative to the circuit module holder.

FIG. 8 is a schematic sectional view of an alternate form of the cursor control device in accordance with the present invention.

### DETAILED DESCRIPTION OF THE PREFERRED EMBODIMENT

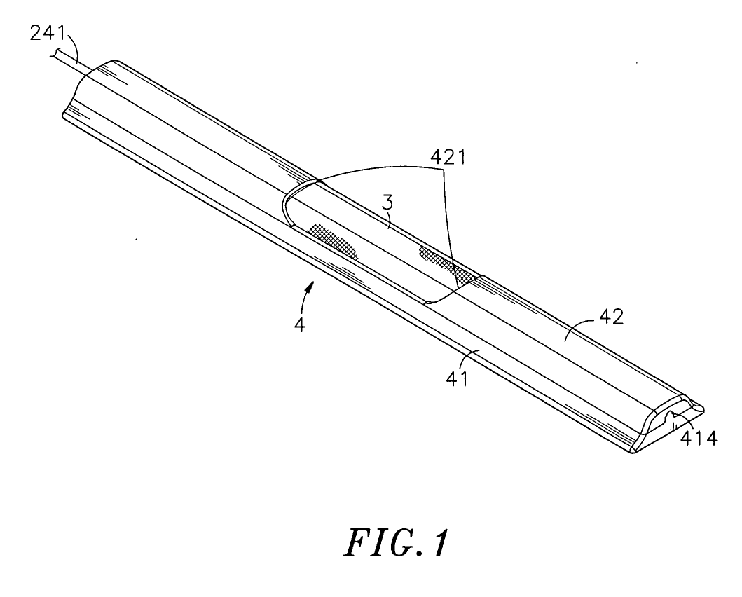

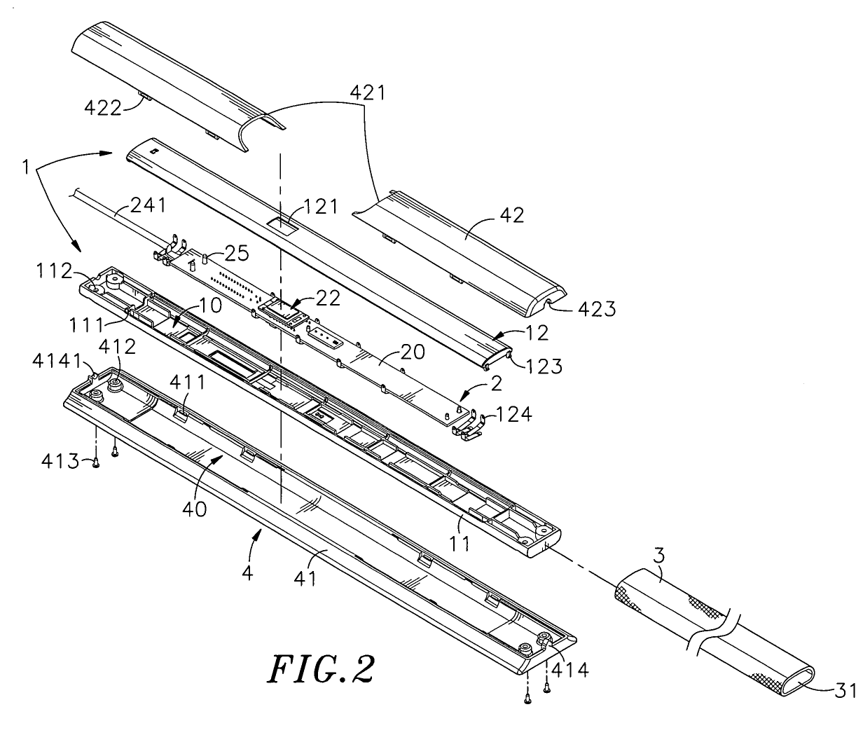

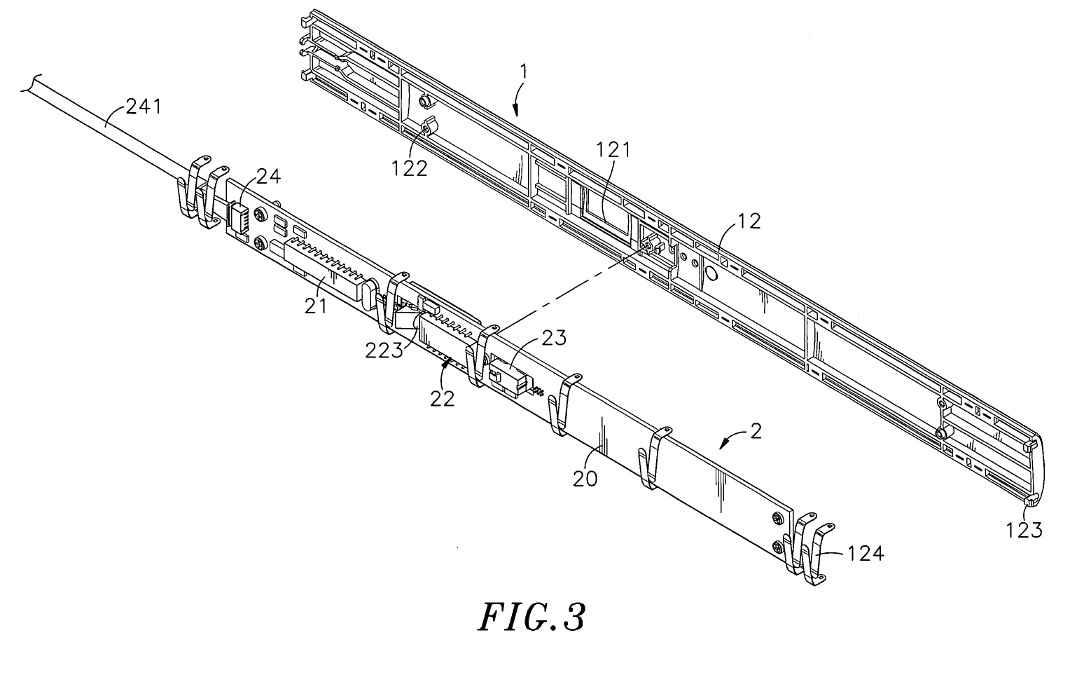

Referring to FIGS. 1, 2 and 3, a cursor control device in accordance with the present invention is shown comprising a circuit module holder 1, a circuit module 2, a sleeve 3 and a housing 4.

The circuit module holder 1 comprises a first holder shell 11 and a second holder shell 12. The first holder shell 11 and the second holder shell 12 define therebetween an accommodation space 10. The first holder shell 11 has a plurality of limiters 111 symmetrically disposed, for example, near two distal ends thereof at two opposite lateral sides relative to the accommodation space 10 and a plurality of locating members 112 symmetrically located on the two distal ends. The second holder shell 12 has an opening 121 cut through the top and bottom walls thereof in communication with the accommodation space 10, a plurality of mounting portions 122 protruded from the bottom wall and a plurality of stop members 123 corresponding to the limiters 111 of the first holder shell 11. Further, elastic members 124 are respectively fastened to the bottom wall of the second holder shell 12 and stopped against the first holder shell 11 to support the second holder shell 12 above the first holder shell 11.

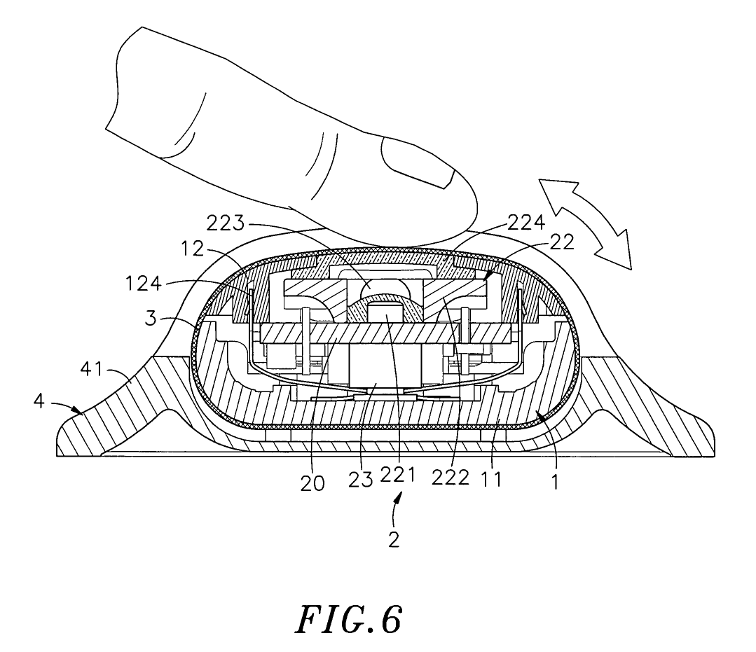

The circuit module 2 is accommodated in the accommodation space 10 in the circuit module holder 1, comprising a circuit board 20 carrying a microprocessor 21, a sensor module 22, a control switch 23 and a transmission interface 24. The circuit board 20 has a plurality of mounting portions 25 respectively fixedly fastened to the mounting portions 122 of the second holder shell 12 of the circuit module holder 1. The sensor module 22, the control switch 23 and the transmission interface 24 are respectively electrically connected to the microprocessor 21. The sensor module 22 is disposed corresponding to the opening 121 of the second holder shell 12 of the circuit module holder 1 for detecting the direction and amount of movement of the sleeve 3 relative to the circuit module holder 1. The transmission interface 24 is adapted for communication with communication interface means of an external computer (not shown). Further, the sensor module 22 comprises a substrate 222, a light source 223 mounted in the substrate 222, a lens 224 molded on the substrate 222 over the light source 223 and inserted into the opening 121 of the second holder shell 12 of the circuit module holder 1 in flush with the top wall of the second holder shell 12 (see FIG. 6) and a sensor 221 installed in the substrate 222 for sensing reflected light from the sleeve 3 upon radiation of the light emitted by the light source 223 through the lens 224.

The sleeve 3 defines an axial hole 31. By means of the axial hole 31, the sleeve 3 is mounted around the circuit module holder 1 and can be moved axially back and forth relative to the circuit module holder 1 and rotated around the circuit module holder 1.

The housing 4 comprises a bottom shell 41 and at least one, for example, two top cover shells 42. The two top cover shells 42 are covered on the top side of the bottom shell 41 such that an accommodation chamber 40 is defined in between the bottom shell 41 and the top cover shells 42 for accommodating the assembly of the sleeve 3, the circuit module holder 1 and the circuit module 2. The bottom shell 41 has a plurality of male hook members (or female hook members) 411 symmetrically disposed at two opposite lateral sides, a plurality of locating members 412 symmetrically disposed near two distal ends thereof and respectively fastened to the locating members 112 of the first holder shell 11 by fastening members 413, two protruding blocks 414 respectively located on the two distal ends. Further, an open space 421 is defined between the two top cover shells 42 corresponding to the opening 121 of the second holder shell 12 of the circuit module holder 1. Further, the two top cover shells 42 have a substantially [symbol] -shaped cross section. Further, each top cover shell 42 has a plurality of female hook members (or male hook members) 422 respectively fastened to the male hook members (or female hook members) 411 of the bottom shell 41 and a locating groove 423 coupled to one of the two protruding blocks 414 of the bottom shell 41.

According to the present preferred embodiment, the circuit module holder 1 is formed of the first holder shell 11 and the second holder shell 12. Alternatively, the circuit module holder 1 can be a single-piece hollow bar having a circular or oval cross section allowing rotation and reciprocating displacement of the sleeve 3 therein. Further, the circuit module holder 1 can be made from polyoxymetylene (POM), polytetrafluoroethylene (PTFE), ultra high molecular weight polyethylene (UHMWPE) or any of a variety of other suitable self-lubricating materials. Further, the sensor module 22 of the circuit module 2 detects the direction and amount of movement of the sleeve 3 in such a manner that the light source 223 emits light through the lens 224 onto the sleeve 3. When the light emitted by the light source 223 falls upon a part of the sleeve 3, the surface characteristic (such as color, raised portions, recessed portions, smoothness) of the radiated part of the sleeve 3 interferes with light, causing a reflected light having a different characteristic to be produced. The sensor 221 senses the reflected light from the sleeve 3 and provides a corresponding signal to the microprocessor 21 for enabling the microprocessor 21 to calculate the direction (in X-axis and Y-axis) and amount of movement of the sleeve 3 relative to the circuit module holder 1 and to produce an output signal indicative of the direction and amount of movement of the sleeve 3 relative to the circuit module holder 1 for transmission through a transmission line 241 of the transmission interface 24 that extends through a hole 4141 on one protruding block 414 of the bottom shell 41 to the communication interface means of the external computer to control movement of a cursor on a display screen (not shown) that is electrically connected to the external computer. The technique how the sensor module 22 of the circuit module 2 emits light and detest reflected light for enabling the microprocessor 21 to calculate the direction and amount of movement of the sleeve 3 is of the known art and not within the scope of the claims of the present invention, and therefore no further detailed description in this regard is necessary. Further, the transmission interface 24 can be a USB, PS2 or any of a variety of other wired communication interfaces. Alternatively, the transmission interface 24 can be infrared, Bluetooth, radio frequency, or any other wireless communication interface. Further, the sleeve 3 can be made from mesh fabric, nonwoven fabric, plastics, rubber or leather, having transversely and longitudinally aligned recessed portions, raised portions or dots and coated with a layer of silver powder or silver paint for enabling the sensor motor 22 to sense the direction and amount of movement of the sleeve 3 relative to the circuit module holder 1 accurately.

During assembly of the cursor control device, the circuit module 2 is accommodated in the accommodation space 10 in the circuit module holder 1, and then the mounting portions 25 of the circuit board 20 are respectively fixedly fastened to the mounting portions 122 of the second holder shell 12 of the circuit module holder 1 to have the light source 223 be inserted into the opening 121 of the second holder shell 12 of the circuit module holder 1 and kept in flush with the top wall of the second holder shell 12. At this time, the stop members 123 of the second holder shell 12 are respectively aimed at the limiters 111 of the first holder shell 11, and the elastic members 124 of the second holder shell 12 are supported on the first holder shell 11. Thereafter, the sleeve 3 is sleeved onto the circuit module holder 1 over the opening 121 to have the circuit module holder 1 be received in the axial hole 31 of the sleeve 3. Thereafter, the sleeve 3 with the circuit module holder 1 are put in the accommodation chamber 40 inside the housing 4, and then the locating members 412 of the bottom shell 41 are respectively fastened to the locating members 112 of the first holder shell 11 by respective fastening members 413 to have the female hook members (or male hook members) 422 and locating groove 423 of the top cover shell 42 be respectively fastened to the male hook members (or female hook members) 411 and protruding blocks 414 of the bottom shell 41. Thus, the cursor control device is well assembled.

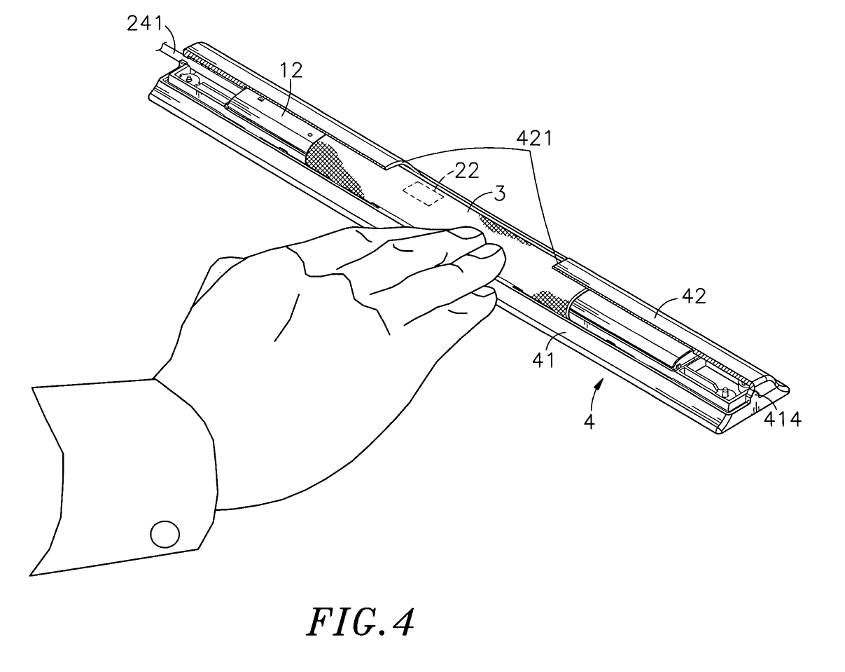

Referring to FIGS. 4˜7, the cursor control device can be used in a personal computer, notebook computer, mobile telephone or any of a variety of personal electronic devices. In case of a wired design, the transmission line 241 of the transmission interface 24 of the cursor control device is connected to the communication interface means of the personal electronic device, for example, personal computer. When the user rests the wrist of the hand on a pad that is disposed adjacent to the cursor control device, the user can move the sleeve 3 in X-axis direction or Y-axis direction relative to the circuit module holder 1 and the housing 4 with the fingers. At this time, the microprocessor 21 outputs an output signal indicative of the direction and amount of movement of the sleeve 3 relative to the circuit module holder 1 through the transmission line 241 of the transmission interface 24 to the communication interface means of the computer to control movement of the cursor on the display screen. Because the circuit module holder 1 is made from a self-lubricating material, it facilitates movement of the sleeve 3, and therefore the sleeve 3 can be moved smoothly in the accommodation chamber 40 inside the housing 4 without causing much friction resistance between the sleeve 3 and the circuit module holder 1.

Further, when the user applies a downward pressure to the sleeve 3, the stop members 123 of the second holder shell 12 are lowered toward the limiters 111 of the first holder shell 11 and the elastic members 124 of the second holder shell 12 are compressed by the first holder shell 11, and at the same time the control switch 23 that is located on the bottom wall of the circuit board 20 is triggered by the first holder shell 11 to produce a triggering signal for controlling the cursor to grab a web page and to scroll up or down the web page or to click a menu selection. When the user stops from moving the sleeve 3, the elastic members 124 immediately lift the second holder shell 12 from the first holder shell 11, returning the second holder shell 12 to its former position.

Further, because the circuit module 2 is accommodated in the accommodation space 10 in the circuit module holder 1 and affixed to the second holder shell 12, the circuit module 2 is protected inside the housing 4 and does not requires an extra installation space in the personal electronic device. Therefore, the cursor control device has an integrated outer appearance and a small-size characteristic.

As stated above, the invention provides a cursor control device applicable for use in a personal computer, notebook computer, mobile telephone or any of a variety of electronic devices for moving a cursor displayed on a display screen or controlling the cursor to grab a web page and to scroll up or down the web page or to click a menu selection. The circuit module holder 1 of the cursor control device accommodates the circuit module 2 on the inside and is received in the sleeve 3 inside the housing 4. Further, two support members 5 may be used to substitute for the aforesaid housing 4 and affixed to the bottom wall of the first holder shell 11 for supporting the circuit module holder 1 on a flat wall, allowing movement of the sleeve 3 relative to the circuit module holder 1 and the circuit module 2 in X-axis and Y-axis directions. This mounting arrangement facilitates cleaning and replacement of the sleeve 3, enhancing the functioning of the cursor control device.

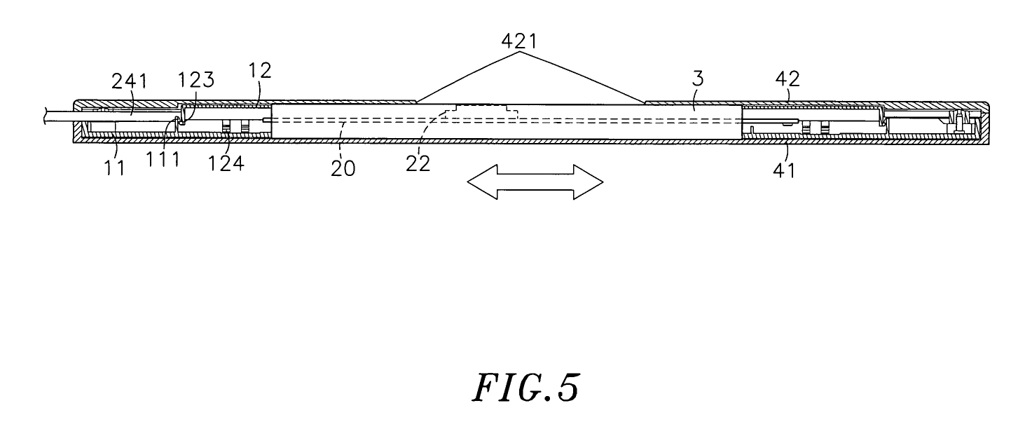

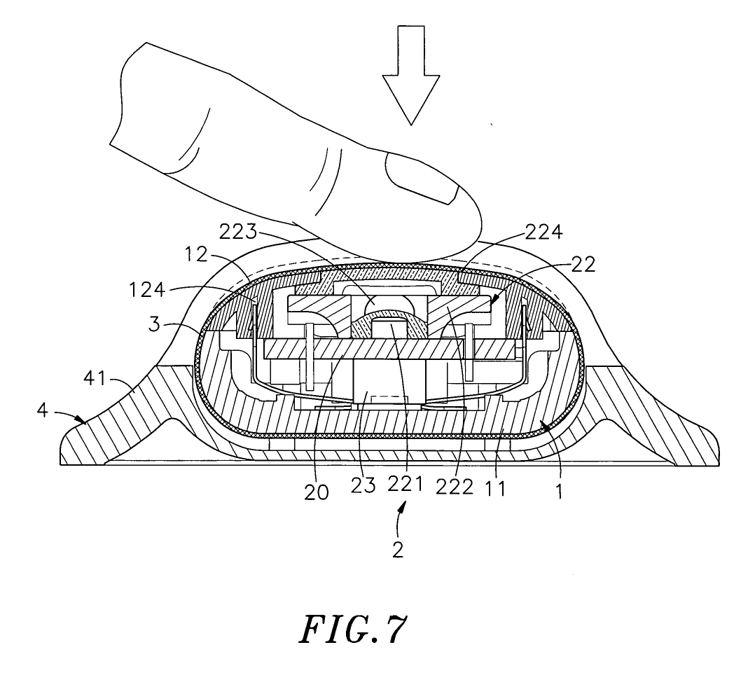

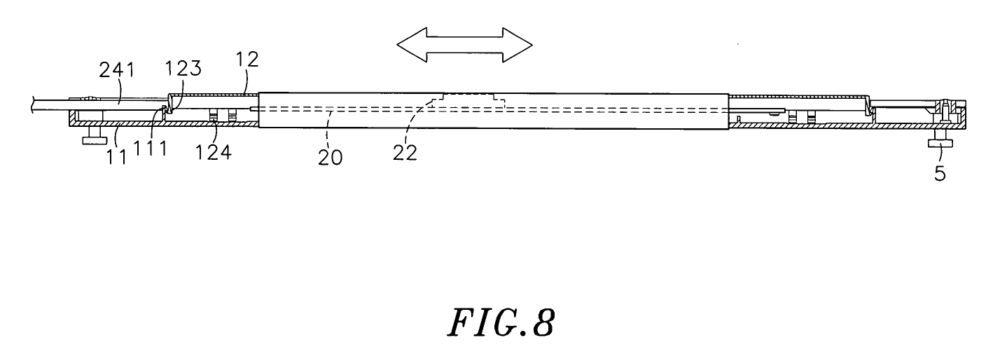

A prototype of cursor control device has been constructed with the features of FIGS. 1-8. The control device functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A cursor control device adapted for controlling a cursor on a display screen of an electronic device, comprising:
a circuit module holder, said circuit module holder having an accommodation chamber defined therein and an opening on a top side thereof in communication with said accommodation chamber;
a sleeve sleeved onto said circuit module holder and movable leftwards and rightwards relative to said circuit module and rotatable forwards and backwards relative to said circuit module;
a circuit module accommodated in said accommodation chamber of said circuit module holder, said circuit module comprising a circuit board, a sensor module installed in said circuit board and adapted for sensing the direction and amount of movement of said sleeve relative to said circuit module holder and producing a signal indicative of the direction and amount of movement of said sleeve relative to said circuit module holder, and a microprocessor installed in said circuit board and electrically connected with said sensor module for receiving the signal produced by said sensor module and producing a control signal for controlling said cursor on said display screen subject to the signal received from said sensor module.

2. The cursor control device as claimed in claim 1, wherein said circuit module holder comprises:
a first holder shell, said first holder shell having a plurality of limiters;
a second holder shell disposed above said first holder shell, said second holder shell having a plurality of stop members downwardly extended from a bottom wall thereof and respectively aimed at said limiters of said first holder shell; and
a plurality of elastic members adapted to support said second holder shell above said first holder shell for enabling said second holder shell to be moved vertically up and down relative to said first holder shell within a predetermined range.

3. The cursor control device as claimed in claim 1, wherein said circuit module holder has a plurality of mounting portions suspending on the inside; said circuit board of said circuit module has a plurality of mounting portions respectively fixedly fastened to the mounting portions of said circuit module holder.

4. The cursor control device as claimed in claim 1, wherein said circuit module further comprises a transmission interface electrically connected with said microprocessor and adapted for transmitting said control signal to said electronic device to control said cursor on said display screen.

5. The cursor control device as claimed in claim 4, wherein said circuit module further comprises a control switch installed in said circuit board and electrically connected with said microprocessor operable to produce a triggering signal when said sleeve is pressed by the user.

6. The cursor control device as claimed in claim 4, wherein said transmission interface is a wired transmission interface selected from a group of universal serial bus interface and PS2 keyboard/mouse interface.

7. The cursor control device as claimed in claim 4, wherein said transmission interface is a wireless transmission interface selected from a group of infrared, Bluetooth and radio frequency transmission techniques.

8. The cursor control device as claimed in claim 1, wherein said sensor module of said circuit module comprises a substrate, a light source mounted in said substrate adapted to emit light onto said sleeve, and a sensor adapted to detect reflected light from said sleeve.

9. The cursor control device as claimed in claim 1, wherein said sleeve defines an axial hole that receives said circuit module holder.

10. The cursor control device as claimed in claim 1, further comprising a housing, said housing comprising a bottom shell, at least one cover shell covering said bottom shell, an accommodation chamber defined in between said bottom shell and said at least one cover shell for accommodating said circuit module and said sleeve for enabling said sleeve to be moved relative to said circuit module, said at least one cover shell each having a plurality of locating members symmetrically disposed near two distal ends thereof respectively fastened to respective locating members at said circuit module holder by fastening members.

11. The cursor control device as claimed in claim 10, wherein said bottom shell has a plurality of first hook members symmetrically disposed at two opposite lateral sides, each said top cover shell has a plurality of second hook members respectively fastened to the male hook members of said bottom shell.

12. The cursor control device as claimed in claim 10, wherein said bottom shell of said housing has two protruding blocks respectively located on two distal ends thereof; said at least one top cover shell of said housing has two locating grooves respectively coupled to the two protruding blocks of said bottom shell.

13. The cursor control device as claimed in claim 10, wherein said circuit module holder has two support members fixedly fastened to a bottom wall thereof for positioning on a flat wall.

14. The cursor control device as claimed in claim 10, wherein said circuit module holder is formed of a first holder shell and a second holder shell and shaped like a hollow bar.

15. The cursor control device as claimed in claim 10, wherein said circuit module holder is prepared from a self-lubricating material selected from the group consisting of polyoxymetylene (POM), polytetrafluoroethylene (PTFE) and ultra high molecular weight polyethylene (UHMWPE).

16. The cursor control device as claimed in claim 10, wherein said sleeve is prepared from one of the materials of mesh fabric and nonwoven fabric.

17. The cursor control device as claimed in claim 10, wherein said sleeve is prepared from one of the materials of plastics and rubber.

18. The cursor control device as claimed in claim 10, wherein said sleeve is prepared from leather.
